(19) United States
(12) Patent Application Publication
(10) Pub. No.: US 2013/0262819 A1
(43) Pub. Date: Oct. 3, 2013

(54) SINGLE CYCLE COMPARE AND SELECT OPERATIONS

(71) Applicants: Srinivasan Iyer, Austin, TX (US); Carsten Aagaard Pedersen, Cambridge, MA (US)

(72) Inventors: Srinivasan Iyer, Austin, TX (US); Carsten Aagaard Pedersen, Cambridge, MA (US)

(21) Appl. No.: 13/437,005

(22) Filed: Apr. 2, 2012

(51) Int. Cl. G06F 9/30; G06F 9/302; G06F 15/78

(52) U.S. Cl. 712/36; 712/220; 712/221; 712/E09.02; 712/E09.023; 712/E09.017

(57) ABSTRACT

An apparatus includes a processor to determine an extremum among a series of values that are successively provided to a first register and a second register. The processor is configured to execute a single cycle search instruction, including compare a value in the first register with a value in a first accumulator, and store an extremum of the two values in the first accumulator; and compare a value in the second register with a value in a second accumulator, and store an extremum of the two values in the second accumulator. The processor is configured to execute a single cycle select instruction, including compare the value in the first accumulator with the value in the second accumulator, and store an extremum of the two values in the first accumulator, the extremum stored in the first accumulator representing the extremum of the series of numbers.

### BACKGROUND

The present disclosure relates to single cycle compare and selection operations.

A digital signal processor (DSP) can perform many types of signal processing, such as processing audio and/or video signals, using algorithms that involve a large number of mathematical operations performed on a large set of data. Compared to general-purpose microprocessors, digital signal processors can perform a narrower range of tasks, but can execute signal processing algorithms more efficiently with a lower latency and lower power consumption. This makes digital signal processors suitable for use in portable devices, such as mobile phones. A digital signal processor may include program memory that stores programs, data memory that stores the information to be processed, and one or more computing engines that perform math processing based on the program from the program memory and the data from the data memory. Examples of signal processing that can be efficiently performed by digital signal processors include audio compression and decompression, image compression and decompression, video compression and decompression, filtering of signals, spectrum analysis, modulation, pattern recognition and correlation analysis.

### SUMMARY

In one aspect, in general, an apparatus includes a processor to determine an extremum among a series of values that are successively provided to a first register and a second register. The processor is configured to execute a single cycle search instruction, including compare a value in the first register with a value in a first accumulator, and store an extremum of the two values in the first accumulator; and compare a value in the second register with a value in a second accumulator, and store an extremum of the two values in the second accumulator. The processor is configured to execute a single cycle select instruction, comprising compare the value in the first accumulator with the value in the second accumulator, and store an extremum of the two values in the first accumulator, the extremum stored in the first accumulator representing the extremum of the series of numbers.

Implementations of the apparatus may include one or more of the following features. In some examples, the extremum includes a maximum. In some examples, the extremum includes a minimum. The processor is configured to execute successive single cycle search instructions to determine two intermediate extremum values among a series of values, store the two intermediate extremum values in the first and second accumulators. The search instruction support four modes that include “less than,” “less than or equal,” “greater than,” and “greater than or equal” modes. The select instruction support four modes that include “less than,” “less than or equal,” “greater than,” and “greater than or equal” modes. The apparatus includes a multiplier-accumulator unit, in which the first and second accumulators are part of the multiplier-accumulator unit. The multiplier-accumulator unit includes multipliers, and the first and second registers store operands for use by the multiplier during multiplication operations. The apparatus includes a multiplexer to direct a number in the first register to the multiplier in response to a multiplication instruction and direct the number in the first register to a compare unit that compares the number in the first register with another number in the first accumulator in response to the single cycle search instruction. The compare unit includes an accumulator adder of the multiplier-accumulator unit. The processor includes pipeline stages having a throughput to allow one single cycle search instruction to be executed every clock cycle. The processor includes pipeline stages having a throughput to allow one single cycle select instruction to be executed every clock cycle.

In another aspect, in general, an apparatus includes a processor to perform functions including multiplication of numbers and determination of an extremum among a series of numbers. The processor includes a multiplier-accumulator (MAC) unit. The MAC unit includes registers to store numbers; multipliers; accumulator adders; multiplexers configured to direct numbers stored in the registers to the multipliers in response to a multiplication instruction, and to direct the numbers stored in the registers to the adders in response to a search instruction; and accumulators to store products resulting from execution of the multiplication instruction or extrema resulting from execution of the search instruction.

Implementations of the apparatus may include one or more of the following features. The processor is configured to execute a single cycle search instruction, including compare, using one of the accumulator adders, a value in a first register with a value in a first accumulator, and store an extremum of the two values in the first accumulator; and compare, using one of the accumulator adders, a value in a second register with a value in a second accumulator, and store an extremum of the two values in the second accumulator. The processor is configured to execute a single cycle select instruction, including compare, using one of the comparator adders, the value in the first accumulator with the value in the second accumulator, and store an extremum of the two values in a register. In some examples, the extremum includes a maximum. In some examples, the extremum includes a minimum. The processor is configured to execute successive single cycle search instructions to determine two intermediate extremum values among a series of values, and store the two intermediate extremum values in a first one of the accumulators and a second one of the accumulators.

In another aspect, in general, a method includes using a digital signal processor to perform computations to generate a series of numbers; providing the numbers to a first register and a second register of the processor; executing a single cycle search instruction; and executing a single cycle select instruction. Executing the single cycle search instruction includes comparing, using a first accumulator adder, a value in the first register with a value in a first accumulator, and storing an extremum of the two values in the first accumulator; and comparing, using a second accumulator adder, a value in the second register with a value in a second accumulator, and store an extremum of the two values in the second accumulator. Executing the single cycle select instruction includes comparing the value in the first accumulator with the value in the second accumulator, and storing an extremum of the two values in the first accumulator, the extremum stored in the first accumulator representing the extremum of the series of numbers.

Implementations of the method may include one or more of the following features. In some examples, the extremum includes a maximum. In some examples, the extremum includes a minimum. The method includes executing successive single cycle search instructions to determine two intermediate extremum values among a series of values, and storing the two intermediate extremum values in the first and second accumulators. The first and second accumulators are part of a multiplier-accumulator unit of the processor, the multiplier-accumulator unit includes a multiplier, and the first and second registers store operands for use by the multiplier during a multiplication operation. The method includes directing a number in the first register to the multiplier in response to a multiplication instruction, and directing the number in the first register to the first accumulator adder to compare the number in the first register with another number in the first accumulator in response to the single cycle search instruction.

### BRIEF DESCRIPTION OF THE DRAWINGS

FIG. 1 is a block diagram of an example multiplier-accumulator (MAC) unit.

FIG. 2 is a schematic diagram of an example multiplier-accumulator (MAC) unit.

FIG. 3 is a flow diagram of an example process for finding a maximum number among a series of numbers.

FIG. 4 is a flow diagram of an example process for finding a minimum number among a series of numbers.

### DETAILED DESCRIPTION

A digital signal processor is often associated with an instruction set that is optimized for the hardware resources of the digital signal processor. Software programs containing instructions are executed to cause the digital signal processor to perform certain signal processing functions. For example, the instruction set for a digital signal processor that has four multipliers may be different from the instruction set for a digital signal processor that has only one multiplier. The instruction set for the digital signal processor having four multipliers may be optimized to use the four multipliers in parallel when performing certain computations.

The following describes two instructions to enable efficient search of the maximum or minimum value among a group of values, and the hardware architecture of the digital signal processor associated with the instructions. The instructions include a vector compare instruction, referred to as the “SEARCH” instruction, and a “SELECT” instruction.

The SEARCH instruction searches for the maximum or minimum of a series of values that are provided to two registers. For example, the processor may implement a decoder that generates a stream of values that are successively stored in two registers. The decoding process may require the values in the registers to be further processed. The SEARCH instruction causes the processor to search for the intermediate maximum or minimum value of half of the series of values, store the intermediate maximum or minimum in a first accumulator, search for the intermediate maximum or minimum value of the other half of the series of values, and store the intermediate maximum or minimum in a second accumulator. The SELECT instruction selects the maximum or minimum of the two values stored in the two accumulators.

The maximum and minimum values are collectively referred to as extremum values. Depending on context, an extremum value can be a maximum value or a minimum value.

The digital signal processor has hardware to support implementing the SEARCH and SELECT instructions as single cycle instructions. The processor has pipeline stages having a throughput such that a SEARCH instruction or a SELECT instruction can be executed every clock cycle.

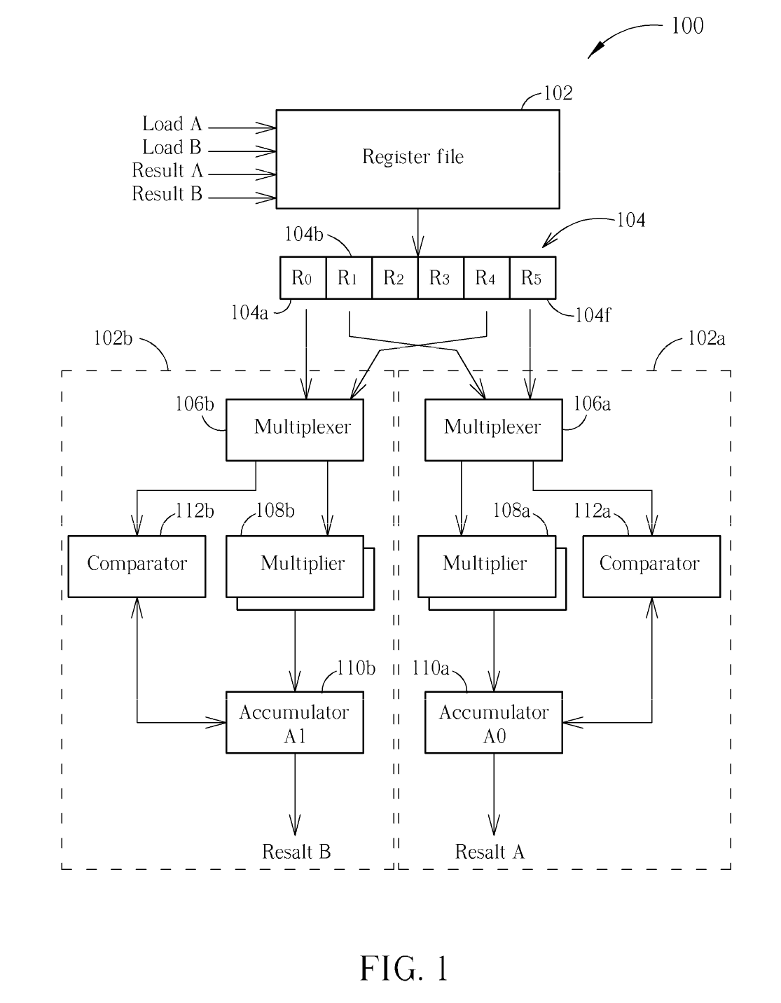

Referring to FIG. 1, in some implementations, a digital signal processor includes a multiplier-accumulator (MAC) unit 100 that can perform multiplication operations and search for the maximum or minimum number among a series of numbers. The MAC unit 100 has multipliers that perform multiplication operations, and accumulators that store the products of the multiplication operations. The SEARCH operation uses the accumulators as temporary storage elements for storing the intermediate maxima or minima. This way, the accumulators can be shared between the multiplication and search operations, reducing the cost of hardware. When designing the MAC unit 100 based on a pre-existing design of a MAC unit that does not support the new SEARCH and SELECT instructions, only a small amount of modification needs to be made to the hardware of the existing MAC unit in order to support the new SEARCH and SELECT instructions.

The MAC unit 100 includes a register file 102 that stores instructions and operands to be processed by the MAC unit 100. In this example, the MAC unit 100 can perform calculations on 32-bit operands, and the register file 102 has eight entries for storing 32-bit operands. The operands are loaded into registers 104 for further processing. In this example, there are six registers: R0 (104a), R1 (104b), . . . , and R5 (104f). The digital signal processor is configured to provide two 32-bit source operands every cycle to an execution unit (not shown in FIG. 1), and in addition allows for a parallel execution of a combination of two loads or a load and a store from external memory (not shown in FIG. 1).

In some examples, the MAC unit 100 includes two pipelines 102a and 102b, each including several pipeline stages (not all stages are shown in the figure). The pipeline 102a includes a multiplexer 106a that directs the operands stored in registers 104 to different units in the pipeline 102a according to the instruction that is being executed. If a multiplication instruction is executed, the multiplexer 106a sends the operands stored in the registers 104 to a multiplier 108a, which outputs a product that is stored in an accumulator 110a. The number stored in the accumulator 110a is referred to as A0.

The pipeline 102b includes a multiplexer 106b that directs the operands stored in registers 104 to different units in the pipeline 102b according to the instruction that is being executed. If a multiplication instruction is executed, the multiplexer 106b sends the operands stored in the registers 104 to a multiplier 108b, which outputs a product that is stored in an accumulator 110b. The number stored in the accumulator 110b is referred to as A1.

If the MAC unit 100 is used to find the (maximum or minimum) number among a series of numbers, the accumulators 110a and 110b are initialized to store the first set of compare data (e.g., the first two numbers in the series of numbers) and a pointer P0 is initialized to contain the index of the first data. Two registers are designated to store the numbers to be compared. For example, registers R0 and R1 can store the numbers to be compared.

In some examples, the structure of the SEARCH instruction is as follows:

(R5,R4)=SEARCH (R1,R0)(LT)∥R3=[P0++](Z)∥NOP;

In this instruction, the numbers in the registers R1 and R0 are simultaneously compared with the numbers A1 and A0 stored in the accumulators 110b and 110a, respectively. Depending on the results from the comparison, the accumulators 110a and 110b are independently updated with the new maximum (or minimum) values. Simultaneously the pointer register value P0 is deposited in the output register pair (R5, R4) to keep track of the index for this maximum or minimum. This is accomplished in a single cycle.

In the example above, the operation “R3=[P0++](Z)” is performed in parallel to the operation “(R5, R4)=SEARCH (R1, R0) (LT),” all in a single cycle. The purpose of the operation “R3=[P0++](Z)” is to increment the index P0. The value in register R3 is not used. In the operation “(R5, R4)=SEARCH (R1, R0) (LT),” a “LT” (or “less than”) mode is selected. The SEARCH instruction supports several modes described below.

When a SEARCH instruction is executed, the multiplexer 106a sends the number stored in the register R0 to a comparator 112a, which compares the number in the register R0 (104a) with a number stored in the accumulator 110a.

The SEARCH instruction supports four modes for finding the maximum or minimum value:

LT: Less than (identifies the first minima)

LE: Less than or equal (identifies the last minima)

GT: Greater than (identifies the first maxima)

GE: Greater than or equal (identifies the last maxima)

When the “less than” mode is selected, if the number in the register 104a is smaller than the number in the accumulator 110a, the number in the register 104a is written into the accumulator 110a, which now stores the current minimum (and also the first minimum, if there are two or more numbers that have the same minimum value) among the numbers compared so far. If the number in the register 104a is equal to or larger than the number in the accumulator 110a, the content of the accumulator 110a is not changed, since it already stores the current minimum.

When the “less than or equal” mode is selected, if the number in the register 104a is smaller than or equal to the number in the accumulator 110a, the number in the register 104a is written into the accumulator 110a, which now stores the current minimum (and also the last minimum, if there are two or more numbers that have the same minimum value) among the numbers compared so far. If the number in the register 104a is larger than the number in the accumulator 110a, the content of the accumulator 110a is not changed, since it already stores the current minimum.

When the “greater than” mode is selected, if the number in the register 104a is larger than the number in the accumulator 110a, the number in the register 104a is written into the accumulator 110a, which now stores the current maximum (and also the first maximum, if there are two or more numbers that have the same maximum value) among the numbers compared so far. If the number in the register 104a is equal to or smaller than the number in the accumulator 110a, the content of the accumulator 110a is not changed, since it already stores the current maximum.

When the “greater than or equal” mode is selected, if the number in the register 104a is larger than or equal to the number in the accumulator 110a, the number in the register 104a is written into the accumulator 110a, which now stores the current maximum (and also the last maximum, if two or more numbers have the same maximum value) among the numbers compared so far. If the number in the register 104a is smaller than the number in the accumulator 110a, the content of the accumulator 110a is not changed, since it already stores the current maximum.

The pipeline 102b operates in a manner similar to that of the pipeline 102a.

When the MAC 100 is used to find the maximum (or minimum) of a series of numbers, pairs of the numbers are successively loaded into the registers R0 and R1, and successive SEARCH instructions are executed until all the numbers have been processed. The accumulator A0 110a stores the maximum (or minimum, depending on the mode chosen for the SEARCH instruction) number among the numbers previously loaded into the register R0, and the accumulator A1 110b stores the maximum (or minimum) number among the numbers previously loaded into the register R1. The pointer P0 is deposited in the output registers pair (R5, R4) to keep track of the index for the maxima or minima.

At the end of several vector compare (SEARCH) instructions, the numbers A1 and A0 stored in the accumulator pair 110b and 110a store the local maxima or minima from the series of numbers. The two output registers R5 and R4 will store the index values for the two maxima or minima. For example, the registers R5 and R4 can be used to determine which one (e.g., the 3^{rd} number or the 10th number) in the series of numbers is the maximum (or minimum). In some examples, a generic way to post process these two results to pick the final maxima or minima is as follows.

// determine true max (greater than or equal) -
CC = A0 < A1; // A0, A1 contain the two last maxima
if !CC R4 = R5; // Assuming (R5, R4) contain the index values
// Select max (result in R2)
R2 = A0;
if !CC R2 = A1;

The register R2 will store the final maximum or minimum and the register R4 will store the corresponding index. This operation takes 4 cycles to complete. The results may be ambiguous if the accumulator values are equal. If the number stored in the accumulator A0 is equal to the number stored in the accumulator A1, in order to obtain the index of the last maxima or minima, it may be necessary to compare the two pointers. This step will require several more cycles.

The new “SELECT” instruction is used to identify the final maximum or minimum after execution of several SEARCH instructions and efficiently reduces the above post processing to a single cycle operation. Furthermore, the SELECT instruction preserves the order of the maxima or minima, as indicated by the various modes.

After several SEARCH instructions have been executed to process the series of numbers, the accumulators A0 and A1 store the maximum (or minimum) numbers among the respective half of the series of numbers. If there are an odd number of numbers in the series, the series is padded with the most positive number possible or the most negative number possible, depending on the mode less than (or equal) and greater than (or equal) respectively such that there are an even number of numbers.

The SELECT instruction selects the maximum (or minimum) number between the two numbers A0 and A1 stored in the accumulators 110a and 110b. In some examples, the general structure of the SELECT instruction is as follows:

(R2,R4)=SELECT (R4,R5)(LT);

In this instruction, two 32-bit compares are performed simultaneously. The first 32-bit compare is between the number stored in accumulators A0 and A1 and the second compare is between the two source registers that represent the index values of the two maxima or minima from previous vector compares. Through efficient re-use of existing hardware, the select instruction can achieve this in a single cycle. In some implementations, the comparisons are performed using accumulator adders (e.g., 214a and 214b) in the MAC unit 100.

Based on the flags from the comparison between A0 and A1, the instruction copies the final accumulator value into the output registers R0. If A0 is the winning value, the index stored in the register R4 will be left unchanged, otherwise R5+1 (i.e., index stored in the register R5 plus 1) will be copied to the register R4.

The +1 operation is implemented by hard-coding bit 0 (the least significant bit). The pointer register is assumed to count even values (2, 4, 6, . . . ), so index+1 is generated by hard-coding the LSB to 1.

Similar to the SEARCH instruction, the SELECT instruction can support four modes:

LT: Less than (identifies the first minimum)

LE: Less than or equal (identifies the last minimum)

GT: Greater than (identifies the first maximum)

GE: Greater than or equal (identifies the last maximum)

If A0 and A1 are equal, the comparison between the two indices is used to further determine which index is to be written out. This makes sure the value of the last minima or maxima for the “LE” or “GE” case is picked and the first minima or maxima for the “LT” or “GT” case is picked.

The SEARCH and SELECT instructions have many applications, such as for use in a Viterbi decoder for finding the minimum distance. The series of numbers for which the maximum or minimum is to be determined can be generated in real time. For example, a decoder may generate a series of numbers, and the SEARCH and SELECT instructions are executed to determine the maximum or minimum among the series of numbers. In the example above, the series of numbers are not loaded from a memory device.

In some examples, the series of numbers for which the maximum or minimum is to be determined are loaded from a memory device.

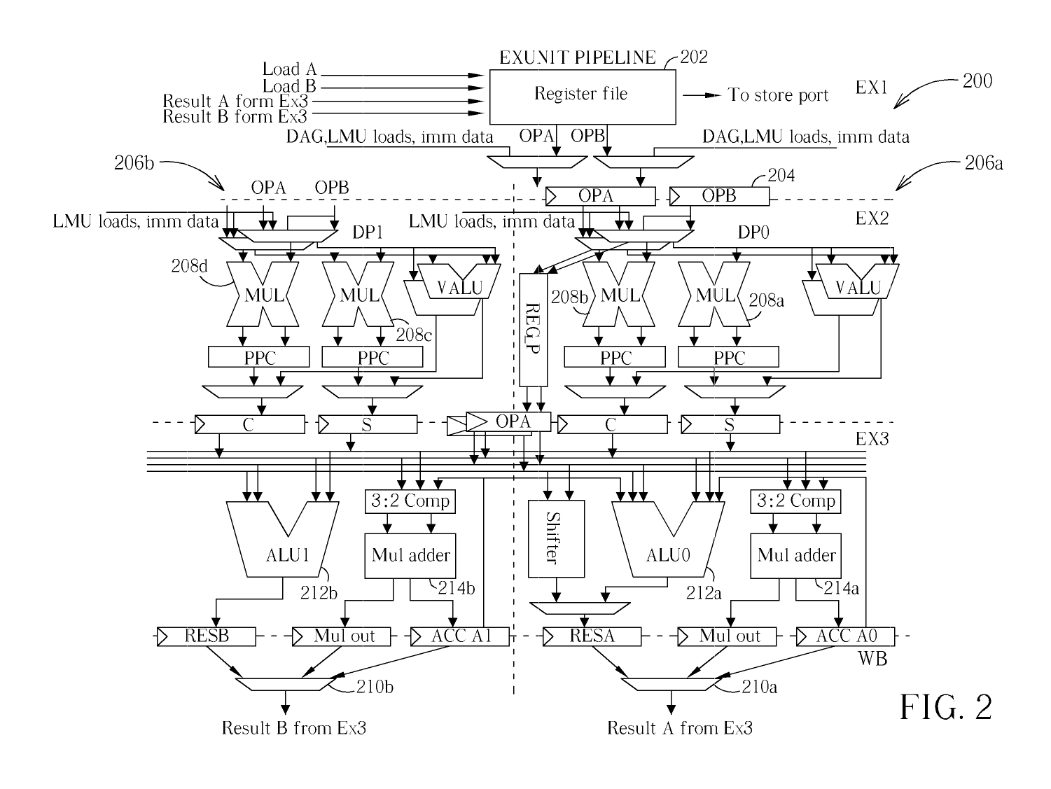

FIG. 2 is a schematic diagram of an example multiplier-accumulator (MAC) unit 200 that can implement the SEARCH and SELECT instructions. The MAC unit 200 includes a register file (with 8 deep, 32 bit wide, 4 write ports, and 3 read ports) 202, registers 204, and pipelines 206a and 206b. The pipeline 206a includes multiplexers (e.g., 17 bit multiplexers (MULs)) 208a and 208b, an arithmetic logic unit 0 (ALU0) 212a and an accumulator 210a. The pipeline 206b includes multiplexers (e.g., 17 bit multiplexers (MULs)) 208c and 208d, an arithmetic logic unit 1 (ALU1) 212b, and an accumulator 210b. The MAC unit 200 functions in a manner similar to that of the MAC unit 100 when executing the SEARCH and SELECT instructions.

In some examples, as an optimization to avoid constructing a separate comparator, a subtractor in the ALU0 212a or ALU1 212b, or the Mul Adder 214a or 214b, can serve as a comparator, e.g., by selecting the sign bit of the subtractor output. The MAC unit 200 may include additional elements, such as partial products compressors (PPCs) and a pipeline register REG_P.

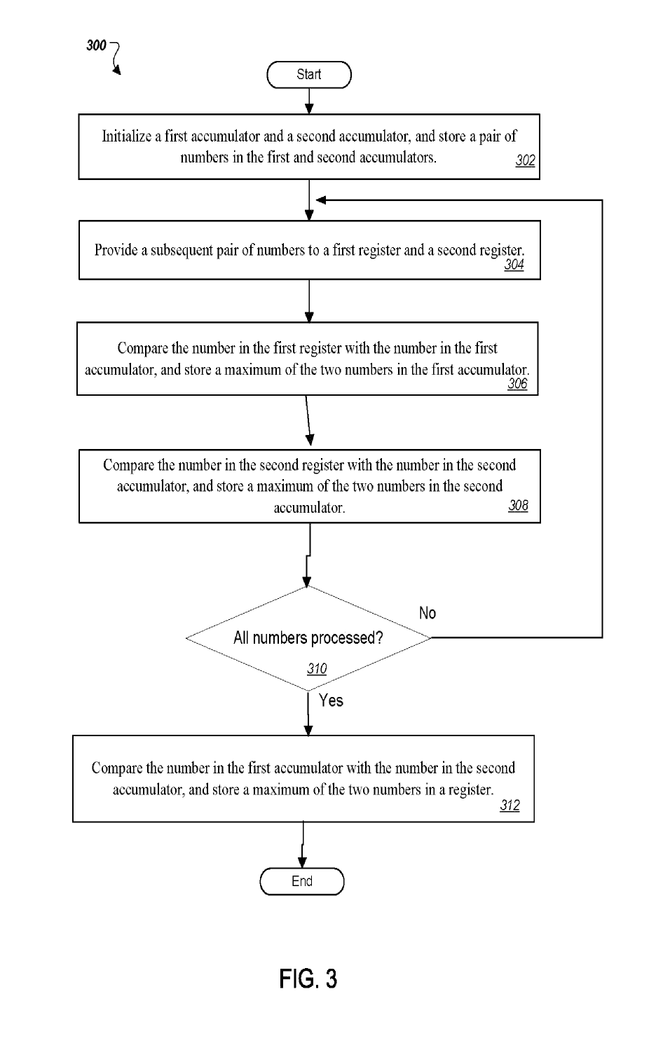

FIG. 3 is a flow diagram of a process 300 for using a digital signal processor to find a maximum number among a series of numbers. A first accumulator and a second accumulator are initialized, and a pair of numbers is stored in the first and second accumulators (302). A subsequent pair of numbers is provided to a first register and a second register (304). The number in the first register is compared with the number in the first accumulator, and a maximum of the two numbers is stored in the first accumulator (306). The number in the second register is compared with the number in the second accumulator, and a maximum of the two numbers is stored in the second accumulator (308). Steps 304 to 308 are repeated until all the numbers in the series of numbers are processed (310). The number in the first accumulator is compared with the number in the second accumulator, and a maximum of the two numbers is stored in a register, the maximum stored in the register representing the maximum of the series of numbers (312).

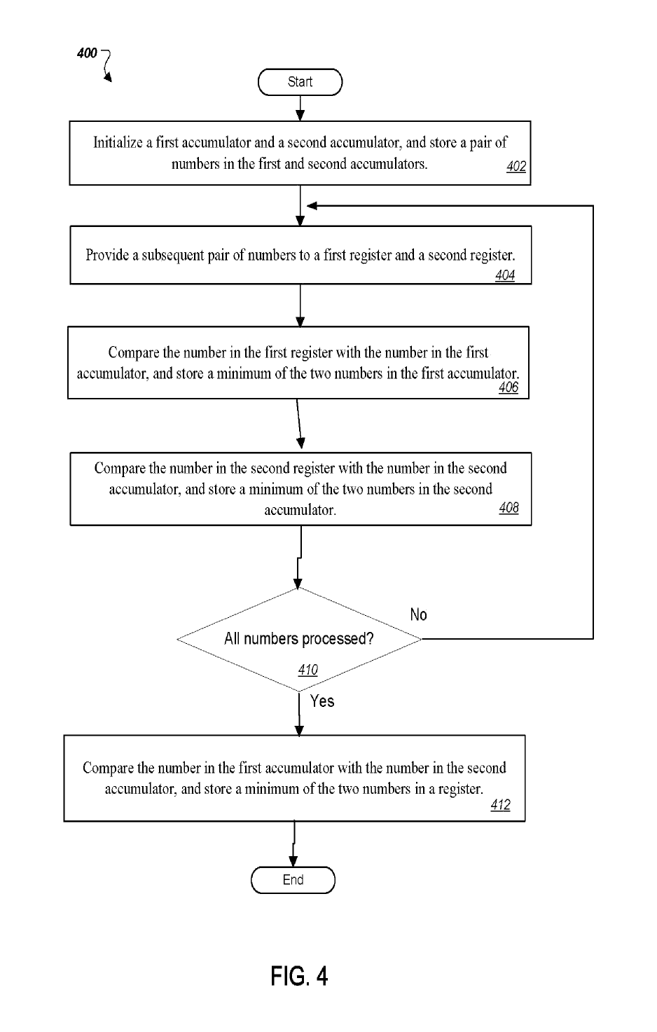

FIG. 4 is a flow diagram of a process 400 for using a digital signal processor to find a minimum number among a series of numbers. A first accumulator and a second accumulator are initialized, and a pair of numbers is stored in the first and second accumulators (402). A subsequent pair of numbers is provided to a first register and a second register (404). The number in the first register is compared with the number in the first accumulator, and a minimum of the two numbers is stored in the first accumulator (406). The number in the second register is compared with the number in the second accumulator, and a minimum of the two numbers is stored in the second accumulator (408). Steps 404 to 408 are repeated until all the numbers in the series of numbers are processed (410). The number in the first accumulator is compared with the number in the second accumulator, and a minimum of the two numbers is stored in a register, the minimum stored in the register representing the minimum of the series of numbers (412).

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems.

For example, the number of bits for each entry in the register file 102, the number of bits of the registers 104, the number of bits that can be handled by the comparators 112, and the number of bits of the accumulators 110 can be different from those described above. There can be more than two pipelines. For example, there can be four pipelines, the series of numbers can be divided into four sets of numbers, the SEARCH instruction can find the local maxima or minima for the four sets of numbers, and the SELECT instruction can find the final maximum or minimum among the four local maxima or minima.

Accordingly, other implementations are within the scope of the following claims.

What is claimed is:

1. An apparatus comprising:
a processor to determine an extremum among a series of values that are successively provided to a first register and a second register, the processor being configured to
execute a single cycle search instruction, comprising
compare a value in the first register with a value in a first accumulator, and store an extremum of the two values in the first accumulator; and
compare a value in the second register with a value in a second accumulator, and store an extremum of the two values in the second accumulator;
execute a single cycle select instruction, comprising
compare the value in the first accumulator with the value in the second accumulator, and store an extremum of the two values in the first accumulator, the extremum stored in the first accumulator representing the extremum of the series of numbers.

2. The apparatus of claim 1 in which the extremum comprises a maximum.

3. The apparatus of claim 1 in which the extremum comprises a minimum.

4. The apparatus of claim 1 in which the processor is configured to execute successive single cycle search instructions to determine two intermediate extremum values among a series of values, store the two intermediate extremum values in the first and second accumulators.

5. The apparatus of claim 1 in which the search instruction support four modes that include “less than,” “less than or equal,” “greater than,” and “greater than or equal” modes.

6. The apparatus of claim 1 in which the select instruction support four modes that include “less than,” “less than or equal,” “greater than,” and “greater than or equal” modes.

7. The apparatus of claim 1, comprising a multiplier-accumulator unit, in which the first and second accumulators are part of the multiplier-accumulator unit.

8. The apparatus of claim 7 in which the multiplier-accumulator unit comprises multipliers, and the first and second registers store operands for use by the multiplier during multiplication operations.

9. The apparatus of claim 8 comprising a multiplexer to direct a number in the first register to the multiplier in response to a multiplication instruction and direct the number in the first register to a compare unit that compares the number in the first register with another number in the first accumulator in response to the single cycle search instruction.

10. The apparatus of claim 9 in which the compare unit comprises an accumulator adder of the multiplier-accumulator unit.

11. The apparatus of claim 1 in which the processor comprises pipeline stages having a throughput to allow one single cycle search instruction to be executed every clock cycle.

12. The apparatus of claim 1 in which the processor comprises pipeline stages having a throughput to allow one single cycle select instruction to be executed every clock cycle.

13. An apparatus comprising:
a processor to perform functions including multiplication of numbers and determination of an extremum among a series of numbers, the processor comprising a multiplier-accumulator (MAC) unit, the MAC unit comprising
registers to store numbers;
multipliers;
accumulator adders;
and multiplexers configured to direct numbers stored in the registers to the multipliers in response to a multiplication instruction, and to direct the numbers stored in the registers to the adders in response to a search instruction; and
accumulators to store products resulting from execution of the multiplication instruction or extrema resulting from execution of the search instruction.

14. The apparatus of claim 13 in which the processor is configured to execute a single cycle search instruction, comprising
compare, using one of the accumulator adders, a value in a first register with a value in a first accumulator, and store an extremum of the two values in the first accumulator; and
compare, using one of the accumulator adders, a value in a second register with a value in a second accumulator, and store an extremum of the two values in the second accumulator.

15. The apparatus of claim 13 in which the processor is configured to execute a single cycle select instruction, comprising
compare, using one of the comparator adders, the value in the first accumulator with the value in the second accumulator, and
store an extremum of the two values in a register.

16. The apparatus of claim 13 in which the extremum comprises a maximum.

17. The apparatus of claim 13 in which the extremum comprises a minimum.

18. The apparatus of claim 13 in which the processor is configured to execute successive single cycle search instructions to determine two intermediate extremum values among a series of values, and store the two intermediate extremum values in a first one of the accumulators and a second one of the accumulators.

19. A method comprising:
using a processor to perform computations to generate a series of numbers;
providing the numbers to a first register and a second register of the processor;
executing a single cycle search instruction, comprising
comparing, using a first accumulator adder, a value in the first register with a value in a first accumulator, and storing an extremum of the two values in the first accumulator; and
comparing, using a second accumulator adder, a value in the second register with a value in a second accumulator, and store an extremum of the two values in the second accumulator;
executing a single cycle select instruction, comprising
comparing the value in the first accumulator with the value in the second accumulator, and storing an extremum of the two values in the first accumulator, the extremum stored in the first accumulator representing the extremum of the series of numbers.

20. The method of claim 19 in which the extremum comprises a maximum.

21. The method of claim 19 in which the extremum comprises a minimum.

22. The method of claim 19, comprising executing successive single cycle search instructions to determine two intermediate extremum values among a series of values, and storing the two intermediate extremum values in the first and second accumulators.

23. The method of claim 19, in which the first and second accumulators are part of a multiplier-accumulator unit of the processor, the multiplier-accumulator unit comprises a multiplier, the first and second registers store operands for use by the multiplier during a multiplication operation, and the method comprises
directing a number in the first register to the multiplier in response to a multiplication instruction, and directing the number in the first register to the first accumulator adder to compare the number in the first register with another number in the first accumulator in response to the single cycle search instruction.
